(19) United States
(12) Patent Application Publication
(10) Pub. No.: US 2017/0000153 A1
(43) Pub. Date: Jan. 5, 2017

(54) LIQUID COFFEE BEVERAGE WITH IMPROVED AROMA

(71) Applicant: NESTEC S.A., Vevey (CH)

(72) Inventors: Carol Borland, Richwood, OH (US); Xiaoping Fu, Dublin, OH (US); Scott A. Westfall, Marysville, OH (US)

(21) Appl. No.: 15/106,415

(22) PCT Filed: Dec. 8, 2014
(86) PCT No.: PCT/EP2014/076918

§ 371 Date: Jun. 20, 2016

Related U.S. Application Data
(60) Provisional application No. 61/918,857, filed on Dec. 20, 2013.

(51) Int. Cl. A23F 5/48; A23F 5/24

(52) U.S. Cl. CPC A23F 5/486; A23F 5/243

(57) ABSTRACT

The present invention relates to a liquid coffee beverage in a closed container with improved aroma having a high ration of high volatile coffee aroma compounds to low volatile coffee aroma compounds in the gaseous headspace, and a method of producing

### FIELD OF INVENTION

The present invention relates to a liquid coffee beverage with improved aroma and a method of producing it.

### BACKGROUND

Liquid coffee beverages sold ready for consumption, sometimes called RTD (ready to drink) coffee beverages are popular and a convenient way to enjoy coffee. These beverages are often enjoyed cold and often include milk and/or sweeteners. In these situations the experience by the consumer of the coffee aroma is limited as compared to a traditional hot cup of coffee, due to the lower temperature and/or the presence of milk and other ingredients which may inhibit the release of coffee aroma compounds. There is therefore a desire to increase the experience of coffee aroma during consumption and also the experience of coffee aroma release when opening of the container, preferably with the use of natural coffee aroma compounds.

During the production of soluble coffee powders, which are obtained from commercial processes involving extraction, concentration, and drying, it is conventional to recover coffee aromas from the roast and ground coffee and to reincorporate these aromas, e.g. into concentrated coffee extract prior to drying into a soluble coffee powder. In this way the aroma perception of the powdered soluble coffee can be increased, as aromas would otherwise be lost during process steps such as extraction and concentration. The coffee aromas may be recovered at several points during processing, e.g. by aroma stripping of roast and ground coffee prior to extraction. WO 01/13735 discloses a method of recovering coffee aroma from coffee grounds comprising wetting, heating and stripping aroma from coffee grounds exposing the coffee grounds to a decreased pressure. The coffee aroma compounds released by this treatment are then recovered. EP 1069830 discloses a method comprising providing a slurry of roast and ground coffee and stripping aroma from this slurry by using a gas to provide an aromatised gas. In both methods aroma compounds are released from roast and ground coffee into a gas phase from where it is collected. The purpose of these methods is to achieve the most effective capture of all aroma compounds and to reincorporate them in the final product to ensure a complete and balanced coffee aroma. Such methods have not been extensively applied to coffee beverages that are distributed and sold in as liquid beverages ready to be consumed, and they have generally been found to be ineffective to deliver the desired aroma release from a cold liquid coffee beverage, especially if the beverage further comprises milk ingredients and/or other additional ingredients. The object of the present invention is to provide a liquid coffee beverage with improved aroma perception upon opening of the can and consumption of the beverage, especially at refrigerated or ambient temperature, and especially when the beverage comprises additional ingredients such as milk solids.

### SUMMARY OF THE INVENTION

The inventors have found that a high ratio of high volatile coffee aroma compounds to low volatile coffee aroma compounds in the headspace above a liquid coffee beverage improves the experience of the coffee aroma by the consumer when opening and consuming the liquid coffee beverage. Consequently, the present invention relates to a liquid coffee beverage in a closed container with a gaseous headspace, the gaseous headspace comprising a ratio of high volatile coffee aroma compounds to low volatile coffee aroma compounds of at least about 1.5 when measured at 25° C.; wherein high volatile coffee aroma compounds are compounds selected among methanethiol, dimethylsulfide, dimethyldisulfide, methylpropanal, 2-methylbutanal, 3-methylbutanal, 2-methyl-furan, N-methyl-pyrrole and combinations thereof; and wherein low volatile coffee aroma compounds are compounds selected among 2-ethyl-5-methylpyrazine, 2-ethyl-6-methylpyrazine, trimethylpyrazine, 2-ethyl-3,5-dimethylpyrazine, 2- ethyl-3,6-dimethylpyrazine, 2,3 -diethyl-5 -methylpyrazine, pyridine, furfural, furfurylalcohol, 5-methylfurfural, guaiacol, ethylguaiacol, vinylguaiacol, acetic acid and combinations thereof. In another aspect the invention relates to a method of producing a liquid coffee beverage in a closed container, the method comprising the following steps: a) stripping coffee aroma from roast and ground coffee with steam to produce steam comprising coffee aroma; b) removing low volatile coffee aroma compounds from the steam comprising coffee aroma; c) recovering high volatile aroma compounds from the steam comprising coffee aroma; d) adding recovered high volatile aroma compounds of step c) to a liquid coffee extract; and e) filling the liquid coffee extract with added high volatile aroma compounds into closed containers to produce a liquid coffee beverage.

### DETAILED DESCRIPTION OF THE INVENTION

The present invention relates to a liquid coffee beverage in a closed container with a gaseous headspace. By a coffee beverage is meant any beverage based on coffee or wherein coffee is an ingredient and wherein the perception of coffee aroma upon opening and/or consumption of the beverage is intended. In a preferred embodiment the liquid coffee beverage comprises between about 0.1% and about 60% (weight/weight) of coffee solids, preferably between about 0.5 and about 50%. In another preferred embodiment the liquid coffee beverage comprises between about 0.1% and about 5% (weight/weight) of coffee solids, preferably between about 0.5 and about 2.5% more preferably between about 0.9% and about 1.6%. By coffee solids is meant any material derived from a coffee plant, preferably from coffee beans. Coffee solids may e.g. be derived from green or roasted coffee beans, preferably from roasted coffee beans. A liquid coffee beverage according to the invention may be a liquid coffee concentrate intended for dilution before consumption. A liquid coffee concentrate may typically comprise between about 10% (weight/weight) and about 60% of coffee solids, accordingly, in a preferred embodiment the liquid coffee beverage comprises between about 10% (weight/weight) and about 60% of coffee solids, preferably between about 20% (weight/weight) and about 50% of coffee solids.

The liquid coffee beverage is in a closed container with a gaseous headspace. By gaseous headspace is meant a volume of gas inside the container wherein volatile compounds, such as volatile coffee aroma compounds, from the liquid beverage will be present in equilibrium with the liquid. When the container is opened by the consumer the gaseous headspace will diffuse out of the container and into the surrounding air, and volatile coffee aroma compounds present in the headspace can be perceived by the consumer upon opening and/or during consumption of the liquid beverage.

The liquid coffee beverage may be in any suitable closed container, such as e.g. containers conventionally used for liquid coffee beverages, such as e.g. aluminium cans, PET bottles, glass bottles, and the like.

The typical aroma of coffee is comprised of a large amount of chemical compounds contributing with different notes and characteristics of the aroma. The volatility of these compounds varies, and they may be divided into classes depending on the volatility. For the purpose of the present invention, high volatile coffee aroma compounds are defined as compounds selected among methanethiol, dimethylsulfide, dimethyldisulfide, methylpropanal, 2-methylbutanal, 3-methylbutanal, 2-methyl-furan, N-methyl-pyrrole and combinations thereof, and low volatile coffee aroma compounds are defined as compounds selected among 2-ethyl-5-methylpyrazine, 2-ethyl-6-methylpyrazine, trimethylpyrazine, 2-ethyl-3,5-dimethylpyrazine, 2-ethyl-3,6-dimethylpyrazine, 2,3-diethyl-5-methylpyrazine, pyridine, furfural, furfurylalcohol, 5-methylfurfural, guaiacol, ethylguaiacol, vinylguaiacol, acetic acid and combinations thereof. All these compounds have been identified as part of coffee aroma, and the present inventors have found that the determination of these compounds and the ratio between high volatile coffee aroma compounds and low volatile coffee aroma compounds in the gaseous headspace is a good indicator of how the coffee aroma is perceived by the consumer when opening the container and/or consuming the beverage.

The present invention relates to a liquid coffee beverage in a closed container with a gaseous headspace, the gaseous headspace comprising a ratio of high volatile coffee aroma compounds to low volatile coffee aroma compounds of at least about 1.5 when measured at 25° C.; wherein high volatile coffee aroma compounds are compounds selected among methanethiol, dimethylsulfide, dimethyldisulfide, methylpropanal, 2-methylbutanal, 3-methylbutanal, 2-methyl-furan, N-methyl-pyrrole and combinations thereof; and wherein low volatile coffee aroma compounds are compounds selected among 2-ethyl-5-methylpyrazine, 2-ethyl-6-methylpyrazine, trimethylpyrazine, 2-ethyl-3,5-dimethylpyrazine, 2-ethyl-3,6-dimethylpyrazine, 2,3 -diethyl-5-methylpyrazine, pyridine, furfural, furfurylalcohol, 5-methylfurfural, guaiacol, ethylguaiacol, vinylguaiacol, acetic acid and combinations thereof. In a preferred embodiment the gaseous headspace comprises a ratio of high volatile coffee aroma compounds to low volatile coffee aroma compounds of at least about 2, more preferably at least about 3, when measured at 25° C.

The amount of high and low volatile coffee aroma compounds in the gaseous headspace can be determined by methods known in the art. A preferred method is the use of Solid Phase Micro Extraction (SPME) of the aroma compounds in the headspace by a fiber coated with Carboxen, Divinylbenzene and Polydimethylsiloxane. Extraction is performed after equilibrating the liquid beverage at 25° C., by contacting the fiber with the gaseous headspace and allowing equilibrium of volatile aroma between the gaseous headspace and the fiber to be reached. Subsequently the volatile aroma compounds are desorbed from the fiber at 250° C. into the inlet port of a gas chromatograph for separation and quantified by mass spectroscopy.

The liquid coffee beverage of the present invention may further comprise milk solids. By milk solids is meant any compound or fraction derived from milk, except water, such as e.g. milk protein, e.g. casein, caseinate, whey protein, whey protein isolate, whey protein concentrate; milk fat; lactose; skim milk; whole milk; cream; milk powder, e.g. skim milk powder, whole milk powder, cream powder; butter fat; and combinations thereof In a preferred embodiment, the liquid coffee beverage of the invention comprises between about 0.5% and about 20% (weight/weight) of milk solids, preferably between about 1% and about 10%, more preferably between about 2% and about 5% of milk solids.

The liquid coffee beverage of the invention may comprise fat and/or oil, e.g. milk fat as part of milk solids, and/or vegetable oil such as e.g. coconut oil, soy oil, palm oil, canola oil, corn oil, safflower oil, and/or sunflower oil. In a preferred embodiment the liquid beverage product comprises between about 0.5% and about 8% of fat and/or oil.

The liquid coffee beverage of the present invention may further comprise one or more sweeteners, e.g. in the form of sugars. The liquid coffee beverage may e.g. comprise one or more sugars selected from the group consisting of lactose, sucrose, fructose, maltose, dextrin, levulose, tagatose, galactose, dextrose, maltodextrin, tapiocadextrin, glucose syrup, tapioca syrup, and combinations thereof. In a preferred embodiment the liquid coffee beverage of the invention comprises between about 1% and about 20% (weight/weight) of sugars, preferably between about 2% and about 15%, more preferably between about 3% and about 10% of sugars.

The product may further comprise buffer salts such as water-soluble potassium or sodium salts to adjust the pH. Any water-soluble buffer salts can be used. In addition to the potassium or sodium salts others such as potassium or sodium carbonate, potassium or sodium bicarbonate, dipotassium or disodium hydrogen phosphate, potassium or sodium dihydrogen phosphate, tripotassium or trisodium phosphate, potassium or sodium hydroxide, potassium or sodium succinate, potassium or sodium malate, potassium or sodium citrate, and mixtures thereof. Preferably, the buffer salt is selected from the group consisting of sodium or potassium bicarbonate, sodium or potassium carbonate, sodium or potassium citrate, and disodium or dipotassium hydrogen phosphate. The pH of the finished product may typically be adjusted to between about 6 and about 8 and preferably between about 6.5 and about 7.7. The potassium or sodium salt may e.g. be present in an amount of from about 0.02% to about 0.2% by weight of the total composition.

The present invention is also related to a method for producing a liquid coffee beverage of the invention. Consequently, in one embodiment, the present invention relates to a method for producing a liquid beverage product in a closed container, the method comprising the following steps: a) stripping coffee aroma from roast and ground coffee to produce gas comprising coffee aroma; b) removing low volatile coffee aroma compounds from the gas comprising coffee aroma; c) recovering high volatile aroma compounds from the gas comprising coffee aroma; d) adding recovered high volatile aroma compounds of step c) to a liquid coffee extract; and e) filling the liquid coffee extract with added high volatile aroma compounds into closed containers to produce a liquid coffee beverage.

Any suitable method of stripping coffee aroma from roast and ground coffee may be used. Several methods for stripping roast and ground coffee are known in the art e.g. from WO 01/13735 where aroma gas is released from roast and ground coffee under decreased pressure and EP 1069830 wherein a gas stream is used for stripping aroma into the gas phase. The stripping step produces a gas comprising volatile coffee aroma compounds and to obtain the ratio of high volatile to low volatile coffee aroma compounds of the product of the present invention, low volatile aroma compounds are removed from the gas comprising coffee aroma. Removal of low volatile coffee aroma compounds may be performed by any suitable method known in the art, e.g. by condensation of the low volatile aromas. Usually, the aroma and water comprising gas will be condensed at a temperature between 0 and 40° C., such as between 5 and 30° C., or between 5 and 20° C. The pressure will usually be between 0.1 and 3 bar absolute pressure, such as between 0.2 and 2 bar absolute pressure, or between 0.3 and 1 bar absolute pressure. Any suitable condenser known in the art may be used. In a preferred embodiment of the invention, the aroma and water containing gas is not subjected to conditions of temperature and pressure whereat water will be in the solid phase (ice). In a further preferred embodiment, the aroma and water comprising gas is subjected to a minimum temperature above 0° C. during the process. The high volatile coffee aroma compounds are recovered from the gas comprising coffee aroma, e.g. by compression of the gas in the presence of an aqueous liquid whereby the high volatile aromas as transferred to the aqueous liquid. The liquid is preferably water, more preferably deoxygenated water. Preferably, the compression is performed at a pressure between 1 and 20 bar absolute pressure, such as between 2 and 15 bar absolute pressure, or between 2 and 8 bar absolute pressure. The pressurisation is performed in the presence of an aqueous liquid. By this is meant that the gas phase is in contact with an aqueous liquid during the pressurisation. The recovered high volatile coffee aroma compounds are added to a liquid coffee extract. The liquid coffee extract may be any liquid coffee extract suitable for producing a coffee beverage, methods of producing coffee extracts are well known in the art of soluble coffee production, e.g. from EP 0826308 and EP 0916267. The liquid coffee extract may be prepared by dissolution of a dried powdered coffee extract in water. The liquid coffee extract with the added high volatile coffee aroma compounds is filled into closed containers to produce a liquid coffee beverage in a closed container with a gaseous headspace. By closed containers is meant containers that after filling are closed so that the liquid beverage as well as the gaseous headspace is retained in the container until it is opened to be consumed. In this way an equilibrium distribution of volatile compounds between the liquid beverage and the gaseous headspace is obtained, allowing the release to the environment of the volatile coffee aroma compounds from the gaseous headspace when the container is opened, which can be perceived by the consumer. After opening further release of volatile coffee aroma compounds will take place from the liquid beverage, allowing the perception of the coffee aroma compounds during consumption of the beverage. The liquid coffee extract with added high volatile aroma compounds is preferably filled into closed containers directly after the addition of the high volatile aroma compounds, as any further storage or processing may result in deterioration of the aroma. In a preferred embodiment the liquid coffee extract with added high volatile aroma compounds obtained in step d) is not subjected to drying.

Additional ingredients may be added to the liquid coffee extract, before, during or after the addition of the high volatile coffee aroma compounds in step d). Any ingredients suitable for addition to a liquid coffee beverage may be added.

### EXAMPLES

Determination of Volatile Coffee Aroma Compounds

The relative amounts of volatile coffee aroma compounds in gaseous headspace were determined by the following method: 0.6 mL of liquid coffee beverage was transferred into 2 mL silated amber vials with crimp caps in duplicate and equilibrated at 25° C. for minimum one hour prior to analysis. Samples were analyzed by headspace-mode using a Gerstel MPS2 autosampler. A 1 cm SPME fiber coated with Carboxen, Divinylbenzene, and Polydimethylsiloxane (Supelco) was inserted into the headspace and allowed to equilibrate for 10 minutes at 25° C. The fiber was removed from the sample and placed into the injection port of a gas chromatograph (GC) (Agilent 6890) for 10 minutes at 250° C. containing a 0.75 mm ID liner (Supelco). During the first 2 minutes of desorption, the purge was off and the last eight minutes with purge on to clean the fiber. GC separation and mass spectrometric detection in SCAN mode (Agilent 5973 MSD Mass Spectrometer (29-300 m/z scan range in EI)) was used for relative quantitation of the aroma compounds.

### Example 1

Two different liquid coffee beverages were produced and filled into closed containers. The composition of both samples is given in table 1.

TABLE 1
Composition of liquid beverage samples

| | % by weight |
|---|---|
| Water | 89.39 |
| Sugar | 5.27 |
| Cow's milk solids | 3.70 |
| Coffee solids (extract of roasted coffee beans) | 1.51 |
| Potassium citrate | 0.03 |
| Sodium bicarbonate | 0.09 |

For sample A (comparative sample), a liquid coffee beverage was produced by the following method: Aroma was stripped from roast and ground coffee using the method disclosed in WO 01/13735, producing a gas comprising volatile coffee aroma compounds. The gas was subjected to condensation at 5° C. and 1 bar to condense water and low volatile coffee aroma compounds out of the gas, producing an aqueous composition of low volatile coffee aroma compounds. To recover the high volatile aroma compounds still present in the gas leaving the condenser, the gas was compressed in a liquid ring compressor at 5° C. and 5 bar in contact with the aqueous liquid comprising the low volatile coffee aroma compounds, resulting in an aqueous aroma liquid comprising both high and low volatile coffee aroma compounds. The stripped roast and ground coffee was extracted with water using conventional technology for soluble coffee extraction. The aqueous aroma liquid comprising both high and low volatile coffee aroma compounds was added to the coffee extract and the coffee extract was dried to a powder. The resulting powder and the remaining ingredients of the coffee beverage were mixed with water to produce a liquid coffee beverage and the liquid coffee beverage was filled into closed containers.

For sample B (product of the invention), a liquid coffee beverage was produced by the following method: Aroma was stripped from roast and ground coffee using the method disclosed in WO 01/13735, producing a gas comprising volatile coffee aroma compounds. The gas was subjected to condensation at 5° C. and 1 bar to condense water and low volatile coffee aroma compounds out of the gas, producing an aqueous composition of low volatile coffee aroma compounds. The stripped roast and ground coffee was extracted with water using conventional technology for soluble coffee extraction. The aqueous aroma liquid comprising low volatile coffee aroma compounds was added to the coffee extract and the coffee extract was dried to a powder. The resulting powder and the remaining ingredients of the coffee beverage were mixed with water to produce a liquid coffee beverage. To recover the high volatile aroma compounds still present in the gas leaving the condenser, the gas was compressed in a liquid ring compressor in contact with the deoxygenated water at 5° C. and 5 bar resulting in an aqueous aroma liquid comprising high volatile coffee aroma compounds. The aqueous aroma liquid comprising high volatile coffee aroma compounds was added to the liquid coffee beverage and the liquid coffee beverage was filled into closed containers.

Sensory Analysis

Both samples were evaluated by a trained sensory panel of 12 panellists experienced in assessing taste differences in coffee products evaluated and compared the samples in a blind comparison. The sensory panel found that sample B gave a significantly higher coffee aroma “burst” upon opening of the closed container and that it had significantly higher levels of coffee aroma and coffee flavour as compared to sample A.

TABLE 2
Relative amounts of volatile coffee aroma compounds in the headspace of
samples A and B of example 1.

| | Sample A | |
|---|---|---|
| | (comparative) | Sample B |
| High volatile coffee aroma compounds: | | |
| methanethiol | 1369 | 10221 |
| dimethylsulfide | 85308 | 984527 |
| dimethyldisulfide | 36788 | 418011 |
| methylpropanal | 674433 | 4086018 |
| 2-methylbutanal | 2031246 | 14901755 |
| 3-methylbutanal | 1004532 | 7588850 |
| 2-methyl-furan | 588316 | 8993207 |
| N-methyl-pyrrole | 264974 | 2576505 |
| Sum of high volatile coffee aroma | 4686964 | 39559092 |
| compounds | | |
| Medium volatile coffee aroma compounds: | | |
| acetaldehyde | 141116 | 949373 |
| propanal | 220300 | 1085883 |
| hexanal | 59123 | 154329 |
| 2,3-butanedione | 89687 | 205328 |
| 2,3-pentanedione | 11146 | 49324 |
| furfurylpyrrole | 59856 | 105074 |
| Sum of medium volatile coffee aroma | 581227 | 2549310 |
| compounds | | |
| Low volatile coffee aroma compounds: | | |
| 2-ethyl-5-methylpyrazine | 100496 | 139507 |
| 2-ethyl-6-methylpyrazine | 150861 | 188143 |
| trimethylpyrazine | 65412 | 47118 |
| 2-ethyl-3,5-dimethylpyrazine | 53515 | 81416 |
| 2-ethyl-3,6-dimethylpyrazine | 20820 | 30032 |
| 2,3-diethyl-5-methylpyrazine | 9044 | 15441 |
| pyridine | 2132002 | 3100374 |
| furfural | 679424 | 1186546 |
| furfurylalcohol | 396008 | 588804 |
| 5-methylfurfural | 282032 | 463936 |
| guaiacol | 14473 | 20018 |
| ethylguaiacol | | |
| vinylguaiacol | 2263 | 3213 |
| acetic acid | 37480 | 68416 |
| Sum of low volatile coffee aroma | 3943826 | 5932959 |
| compounds | | |
| Ratio of high volatile coffee aroma | 1.2 | 6.7 |
| compounds to low volatile coffee aroma | | |
| compounds | | |

### Example 2

The following commercial liquid coffee beverage products comprising milk solids in closed containers available in retail were analysed for volatile coffee aroma compounds present in the headspace:

C: NESCAFE® KOMIBAISEN (Japan)

D: NESCAFE® ORIGINAL (Malaysia)

E: AROMAX® LATTE (Japan)

Result are given in Table 3

TABLE 3
Relative amounts of volatile coffee aroma compounds in the headspace of
samples C, D and E of example 2.

| | C | D | E |
|---|---|---|---|
| High volatile coffee aroma | 3627 | 102 | 0 |
| compounds: | | | |
| methanethiol | 372464 | 2516 | 2397 |
| dimethylsulfide | 337667 | 397 | 15 |
| dimethyldisulfide | 2251657 | 29082 | 44550 |
| methylpropanal | 8508511 | 94669 | 140829 |
| 2-methylbutanal | 3349625 | 37181 | 29393 |
| 3-methylbutanal | 9988593 | 43567 | 20508 |
| 2-methyl-furan | 3377056 | 5484 | 31151 |
| N-methyl-pyrrole | 28189200 | 212996 | 268842 |
| Sum of high volatile coffee aroma | 3627 | 102 | 0 |
| compounds | | | |
| Medium volatile coffee aroma | | | |
| compounds: | | | |
| acetaldehyde | 515847 | 25907 | 24058 |
| propanal | 532162 | 8327 | 13645 |
| hexanal | 70281 | 1614 | 1839 |
| 2,3-butanedione | 196991 | 8040 | 8065 |
| 2,3-pentanedione | 162987 | 1585 | 157 |
| furfurylpyrrole | 427531 | 2175 | 4411 |
| Sum of medium volatile coffee | 1905799 | 47648 | 52174 |
| aroma compounds | | | |
| Low volatile coffee aroma | | | |
| compounds: | | | |
| 2-ethyl-5-methylpyrazine | 418763 | 7659 | 21667 |
| 2-ethyl-6-methylpyrazine | 690908 | 14105 | 41375 |
| trimethylpyrazine | 387549 | 6125 | 21443 |
| 2-ethyl-3,5-dimethylpyrazine | 200608 | 4015 | 12958 |
| 2-ethyl-3,6-dimethylpyrazine | 83057 | 1605 | 4464 |
| 2,3-diethyl-5-methylpyrazine | 27830 | 662 | 1938 |
| pyridine | 17587843 | 325075 | 1149900 |
| furfural | 4496560 | 45556 | 77038 |
| furfurylalcohol | 6637485 | 48677 | 282149 |
| 5-methylfurfural | 3712442 | 12218 | 44127 |
| guaiacol | 434809 | 1992 | 18136 |
| ethylguaiacol | 100646 | 34 | 4006 |
| vinylguaiacol | 147599 | 538 | 173 |
| acetic acid | 311298 | 7758 | 6660 |
| Sum of low volatile coffee aroma | 35237397 | 476017 | 1686030 |
| compounds | | | |
| Ratio of high volatile coffee aroma | 0.8 | 0.4 | 0.2 |
| compounds to low volatile coffee | | | |
| aroma compounds | | | |

### Example 3

A liquid coffee beverage (sample F) was produced with the same composition as given in table 1:

Aroma was stripped from roast and ground coffee using the method disclosed in WO 01/13735, producing a gas comprising volatile coffee aroma compounds. The gas was subjected to condensation at 5° C. and 1 bar to condense water and low volatile coffee aroma compounds out of the gas, producing an aqueous composition of low volatile coffee aroma compounds, which was not used for this sample. To recover the high volatile aroma compounds still present in the gas leaving the condenser, the gas was compressed in a liquid ring compressor in contact with the deoxygenated water at 5° C. and 5 bar resulting in an aqueous aroma liquid comprising high volatile coffee aroma compounds. The stripped roast and ground coffee was extracted with water using conventional technology for soluble coffee extraction and the extract was dried into a powder. The resulting powder and the remaining ingredients of the coffee beverage were mixed with water to produce a liquid coffee beverage and liquid comprising high volatile coffee aroma compounds were added to the liquid beverage and the liquid beverage was filled into closed containers.

The liquid coffee beverage was analysed for volatile coffee aroma compounds in the headspace. Results are given in Table 4.

### Example 4

A liquid coffee beverage (sample G) was produced with the same composition as given in table 1. Aroma was stripped from roast and ground coffee using the method disclosed in WO 01/13735, producing a gas comprising volatile coffee aroma compounds. The gas was subjected to condensation at 5° C. and 1 bar to condense water and low volatile coffee aroma compounds out of the gas, producing an aqueous composition of low volatile coffee aroma compounds. To recover the high volatile aroma compounds still present in the gas leaving the condenser, the gas was compressed in a liquid ring compressor in contact with the aqueous liquid comprising the low volatile coffee aroma compounds (5° C. and 5 bar), resulting in an aqueous aroma liquid comprising both high and low volatile coffee aroma compounds. The stripped roast and ground coffee was extracted with water using conventional technology for soluble coffee extraction. The aqueous aroma liquid comprising both high and low volatile coffee aroma compounds was added to the coffee extract and the extract was dried to a powder. The resulting powder and the remaining ingredients of the coffee beverage were mixed with water to produce a liquid coffee beverage and the liquid coffee beverage was filled into closed containers.

The liquid coffee beverage was analysed for volatile coffee aroma compounds in the headspace. Results are given in Table 4.

The sensory panel found that sample F had a significantly higher aroma “burst” upon opening of the closed container than sample G. Sample F also had a higher level of coffee aroma and coffee flavour, and significantly less milky flavor than sample G.

TABLE 4
Relative amounts of volatile coffee aroma compounds in the headspace of
samples F.

| | Sample F | Sample G |
|---|---|---|
| High volatile coffee aroma compounds: | | |
| methanethiol | 6207 | 6334 |
| dimethylsulfide | 590282 | 104880 |
| dimethyldisulfide | 283157 | 143594 |
| methylpropanal | 5161234 | 734200 |
| 2-methylbutanal | 14174241 | 1907811 |
| 3-methylbutanal | 5568639 | 735878 |
| 2-methyl-furan | 3937693 | 676591 |
| N-methyl-pyrrole | 2163105 | 205727 |
| Sum of high volatile coffee aroma compounds | 31884556 | 4515013 |
| Medium volatile coffee aroma compounds: | | |
| acetaldehyde | 1656510 | 334812 |
| propanal | 1284903 | 154584 |
| hexanal | 117963 | 56777 |
| 2,3-butanedione | 257545 | 146319 |
| 2,3-pentanedione | 97338 | 15435 |
| furfurylpyrrole | 72906 | 48780 |
| Sum of medium volatile coffee aroma | 3487165 | 756706 |
| compounds | | |
| Low volatile coffee aroma compounds: | | |
| 2-ethyl-5-methylpyrazine | 142943 | 134101 |
| 2-ethyl-6-methylpyrazine | 261210 | 239602 |
| trimethylpyrazine | 101601 | 94106 |
| 2-ethyl-3,5-dimethylpyrazine | 67400 | 58292 |
| 2-ethyl-3,6-dimethylpyrazine | 34283 | 32228 |
| 2,3-diethyl-5-methylpyrazine | 11267 | 9431 |
| pyridine | 5541614 | 5547043 |
| furfural | 1443115 | 1028611 |
| furfurylalcohol | 1387009 | 1370089 |
| 5-methylfurfural | 376846 | 242145 |
| guaiacol | 49581 | 51330 |
| ethylguaiacol | 5937 | 5826 |
| vinylguaiacol | 66240 | 79725 |
| acetic acid | 109658 | 110880 |
| Sum of low volatile coffee aroma compounds | 9598702 | 9003407 |
| Ratio of high volatile coffee aroma compounds | 3.3 | 0.5 |
| to low volatile coffee aroma compounds | | |

1. A liquid coffee beverage in a closed container with a gaseous headspace, the gaseous headspace comprising a ratio of high volatile coffee aroma compounds to low volatile coffee aroma compounds of at least about 1.5 when measured at 25° C.; wherein high volatile coffee aroma compounds are compounds selected from the group consisting of methanethiol, dimethylsulfide, dimethyldisulfide, methylpropanal, 2-methylbutanal, 3-methylbutanal, 2-methyl-furan, N-methyl-pyrrole and combinations thereof; and wherein low volatile coffee aroma compounds are compounds selected from the group consisting of 2-ethyl-5-methylpyrazine, 2-ethyl-6-methylpyrazine, trimethylpyrazine, 2-ethyl-3,5-dimethylpyrazine, 2-ethyl-3,6-dimethylpyrazine, 2,3 -diethyl-5-methylpyrazine, pyridine, furfural, furfurylalcohol, 5-methylfurfural, guaiacol, ethylguaiacol, vinylguaiacol, acetic acid and combinations thereof.

2. A liquid coffee beverage according to claim 1, wherein the gaseous headspace comprising a ratio of high volatile coffee aroma compounds to low volatile coffee aroma compounds of at least about 2 when measured at about 25° C.

3. A liquid coffee beverage according to any of claim 1, wherein the gaseous headspace comprising a ratio of high volatile coffee aroma compounds to low volatile coffee aroma compounds of at least about 3 when measured at 25° C.

4. A liquid coffee beverage according to claim 1, wherein the liquid beverage comprises between about 0.1% and about 60% of coffee solids.

5. A liquid coffee beverage according to claim 1, wherein the liquid beverage comprises between about 0.1% and about 5% of coffee solids.

6. A liquid coffee beverage according to claim 1, wherein the liquid beverage comprises between about 10% and about 60% of coffee solids.

7. A liquid coffee beverage according to claim 1 comprising between about 0.5% and about 20% of milk solids.

8. A liquid coffee beverage according to claim 1 comprising between about 1% and about 20% of sugars.

9. A liquid coffee beverage according to claim 1 comprising between about 0.5% and about 8% of fat or oil.

10. A liquid coffee beverage according to claim 1 comprising at least one buffer salt selected from the group consisting of sodium or potassium bicarbonate, sodium or potassium carbonate, sodium or potassium citrate, and disodium or dipotassium hydrogen phosphate.

11. A method of producing a liquid coffee beverage in a closed container, the method comprising the following steps:
a) stripping coffee aroma from roast and ground coffee with steam to produce steam comprising coffee aroma;
b) removing low volatile coffee aroma compounds from the steam comprising coffee aroma;
c) recovering high volatile aroma compounds from the steam comprising coffee aroma;
d) adding recovered high volatile aroma compounds of step c) to a liquid coffee extract; and
e) filling the liquid coffee extract with added high volatile aroma compounds into closed containers to produce a liquid coffee beverage.

12. The method of claim 11 wherein the liquid coffee extract with added high volatile aroma compounds obtained in step d) is not subjected to drying.
